(19) United States
(12) Patent Application Publication
(10) Pub. No.: US 2004/0045217 A1
(43) Pub. Date: Mar. 11, 2004

(54) Cohesive soil plugs for use in plant production

(76) Inventors: Kelvin Spencer Chiddick, North Vancouver (CA); Laura Principe, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/236,967

(22) Filed: Sep. 9, 2002

(51) Int. Cl. A01G 31/00

(52) U.S. Cl. 47/59 S

(57) ABSTRACT

This invention relates to novel formulations for cohesive soil plugs used in plant nurseries. More particularly, this invention pertains to novel compositions for forming soil plugs for use in plant propagation that resist disintegration when the soil plugs containing germinating seedlings are relocated from small growth containers to larger growth containers. An adhesive soil mixture comprising: (a) growing medium; and (b) a binder containing one or more of bentonite and cellulose alkyl ether.

### FIELD OF THE INVENTION

This invention relates to novel formulations for cohesive soil plugs used in plant production. More particularly, this invention pertains to novel compositions for forming soil plugs for use in plant propagation. During patching and transplanting, these soil plugs resist disintegration as seedlings and cuttings are relocated from small growth containers to larger growth containers.

### BACKGROUND

Today, in plant propagation facilities, seedling soils, potting soils, and the like, are mixed by a soil processing company and delivered to the grower's location. The growers fill trays, which contain a plurality of seedling cells, with the appropriate soil. Normally the tray filling process is automated. Once trays are filled with soil, the grower will either sow seeds or stick cuttings into the cells. The trays are placed in greenhouses and fed and watered on a regular basis. Root development normally takes between two to ten days. Plant propagators will remove plugs (seedlings or cuttings plus the soil and root ball) from trays during this time for ‘patching’ or transplanting. In order to maximize space and ensure a certain percentage of useable cells (cells with quality plants) per tray, growers will ‘patch’ trays. In this situation, the unusable cells in a tray are removed and replaced with useable plugs. As seedlings and cuttings develop, a propagator will transplant plugs from small cells to larger cells or pots. Typically, during the transplanting process, some or a good part of the soil falls off the roots causing transplant shock. Transplant shock has been an ongoing problem for growers because it may significantly increase crop production time and or plant losses. Reducing or eliminating transplant shock, in the transplanting and patching stages would allow growers to both shorten the time required to produce a crop and increase the number of useable cells in a tray.

Current approaches to soil stabilization for manufacturing plant growing media as disclosed in the literature include gels, thermoplastic foams, synthetic fibers, polymer emulsions, and the like. Rubber dirt plugs made from polyurethane foam and soil are available in the industry but they are not ideal for all growers. U.S. Pat. No. 5,099,604, granted Mar. 31, 1992, Moffet, discloses a plant growth media that comprises small tufts of mineral wool having dispersed therein, particles of acidic phenolic resin for pH control and particles of vermiculite. The invention purports to result in a lightweight growth media having suitable pH for growing certain plants while also providing for flowability, enhanced water absorption and cohesiveness which prevents the composition from spilling out of certain types of plant containers.

U.S. Pat. No. 5,791,085, Bonnette et al., granted Aug. 11, 1998, discloses a porous solid material for plant propagation which includes granules of a porous expanded material such as perlite or vermiculite, distributed within a porous, open-cell foamed hydrophilic water-retentive polyurethane matrix. The material may be molded into sheets of break-off units for seed germination and propagation.

U.S. Pat. No. 5,060,418, Pullman et al., granted Oct. 29, 1991, discloses a method for treating a plant growth medium containing a plant so that the growth medium remains intact around the roots during transplanting operations. This involves treating the growth medium shortly before transplanting with an adhesive-forming substance which will bond the particles of the growth medium to form an intact plug. The adhesive-forming substance must be physiologically innocuous. Materials such as warm solution of agar or soluble alginates are said to be suitable.

U.S. Pat. No. 4,656,811, Dedolph, granted Apr. 14, 1987, discloses a continuous molding machine for forming two chains of soil plugs for use in germinating seeds or otherwise growing plants. A continuous sheet of paper is corrugated to conform to a series of mold elements and a reaction mixture of polymerizing agent in soil slurries added over the paper to conform to the mold element shape. Another sheet of paper is added over the top of the mixture and the entire assembly is then passed under a series of pressure belts during which time the mixture is cured. The chain of soil plugs which emerges from the pressure belts is encased on both side by paper and may be cut to provide a pair of separate soil plug chains.

U.S. Pat. No. 4,495,310, Dedolph, granted Jan. 22, 1985, discloses a method of forming a urethane prepolymer comprising the steps of gradually adding an isocyanate compound to a hydrophilic polyether or polyester compound without substantial added mixing whereby a relatively dense isocyanate layer and a polyether or polyester layer overlying the isocyanate layer are formed and urethane prepolymer-forming reaction occurs at the interface between the layers. The resulting urethane prepolymer may be reacted with water to form a cellular urethane polymer, or with an aqueous slurry of unconsolidated aggregate material to form a consolidated aggregate product such as a plant growth supporting rooting medium.

U.S. Pat. No. 6,287,356, Wommack et al., granted Sep. 11, 2001, discloses mechanically strong water disintegrable conglomerates for use as soil conditioner produced from cement kiln dust and other particulate calcium sources containing calcium oxide or calcium dihydroxide and other calcium containing compounds having the potential to be hydrated and a process for forming such agglomerates. The process comprises combining the particulate calcium source and a water soluble binder to produce agglomerates which are then subjected to controlled drying.

U.S. Pat. No. 5,934,011, Ishioka et al., granted Aug. 10, 1999, discloses a seedling culture mat comprising a mat which comprises a fibrous substrate or a water-soluble film or paper, a non-ionic water-absorbing polymer in a film, tape, fiber or powder form which is anchored to the mat and seeds which are applied on the mat.

U.S. Pat. No. 4,034,508, Dedolph, granted Jul. 12, 1997, discloses a polymerized soil plug with a growing plant molded therein comprising a body of spongy open-celled hydrophilic polymer, a growing plant having the roots thereof in the body of the spongy polymer and having the stalk thereof extending outwardly from one surface and a quantity of particles of soil mix distributed throughout the body of the spongy polymer, a quantity of synthetic organic plastic resin being reacted in situ to form the body spongy open-celled hydrophilic polymer binding the particles of soil mix therein and into a plug and binding the roots in the plug. The soil mix comprises from about 20% to about 80% by dry weight of the soil plug and the roots are distributed substantially uniformly throughout the adjacent portions of the plug. A package for retail sale of the soil plugs with growing plants therein is also disclosed.

U.S. Reissue Pat. No. 32,808, Wingerden, Dec. 27, 1988, discloses a seedling growing container wherein a number of removable partitions or barriers are positioned together in a block. Each of the partitions has interconnected diverging walls forming a series of troughs there between open at the top and the bottom so that the partitions may be placed in opposing relationship as in a tray forming growing compartments from each of the opposing troughs. The troughs are suitable for growing single seedlings.

### SUMMARY OF INVENTION

The invention is directed to an adhesive soil mixture comprising: (a) growing medium; and (b) a binder selected from one or more of the group consisting of bentonite and cellulose alkyl ether.

The growing medium can be one or more of peat moss, perlite, vermiculite, sulfur, boron, copper, iron, manganese, molybdenum, zinc, gypsum, dolomite, limestone, hydrated limestone, monopotassium phosphate, single super phosphate, calcium nitrate, potassium nitrate, iron sulphate, and/or wetting agent. The binder can be bentonite, cellulose alkyl ether, cellulose methyl ether, bentonite and cellulose alkyl ether, or bentonite and cellulose methyl ether.

The mixture can comprise about 150 parts growing medium and about 1 to 20 parts bentonite. The proportion of bentonite can be about 10 parts to about 150 parts growing medium. The mixture can include 0.1 to 2 parts carboxyvinyl polymer. The mixture can comprise about 150 parts growing medium, about 1 to 20 parts bentonite and about 0.1 to 4 parts cellulose methyl ether.

The invention is also directed to a composition suitable for forming soil plugs comprising: (a) about 150 parts growing medium; (b) about 10 parts bentonite; (c) about 1 part cellulose methyl ether. Cellulose hydroxy ethyl ether can be substituted for cellulose methyl ether.

The growing medium containing binding agent may be put into trays loose at the grower's location (called ‘loose-fill’). Alternatively, the preferred growing medium may be premixed with an equal portion of water in a high speed mixer to wet out the soil and introduce air pockets into the mix. The aerated slurry is then poured into trays and allowed to sit dry for twenty-four hours while excess water drains. Once adequately dry, the ‘pre-filled’ trays are shipped to the grower's location and seeded or stuck.

### BRIEF DESCRIPTION OF DRAWINGS

In drawings which illustrate specific embodiments of the invention, but which should not be construed as restricting the spirit or scope of the invention in any way:

FIG. 1 illustrates a graph of average plug length for various treatments over four sampling dates.

FIG. 2 illustrates a graph of germination rates of various treatments over four sampling dates.

FIG. 3 illustrates a graph of plant development of various treatments over four sampling dates.

FIG. 4 illustrates a graph of the effect of binding agent on average percent plug length for Geranium in seedling soil.

FIG. 5 illustrates a graph of the effect of binding agent on average percent plug length for Rudebeckia in seedling soil.

FIG. 6 illustrates a graph of breakdown of treatment means for Geranium in seedling soil.

FIG. 7 illustrates a graph of breakdown of treatment means of for Rudebeckia in seedling soil.

FIG. 8 illustrates a graph of the effect of treatment on average percent plug length for Gerbera in #72 soil.

FIG. 9 illustrates a graph of the effect of sampling date on average percent plug length for Gerber in #72 soil.

FIG. 10 illustrates a graph of % plug length for Ajuga over four dates.

FIG. 11 illustrates a graph of % plug length for Herman's Pride over four dates.

FIG. 12 illustrates a graph of % plug length for Gentians over four dates.

FIG. 13 illustrates a graph of % plug length for Ceratostigma over three dates.

FIG. 14 illustrates a graph of treatment means for coleus eye cuttings.

### DETAILED DESCRIPTION OF SPECIFIC EMBODIMENTS OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

There is a strong need for an efficient and inexpensive bulk binding media which can be used at the plant propagators' site with existing in-house tray-filling equipment. Most large greenhouse operations today prefer to fill the cells in their trays with loose soil of specific formulations obtained from a soil processor. Suitable bulk binding media must enable growers to continue production with existing equipment and preferred plug sizes. Such bulk binding media should include cohesive additives, which can be added at various percentages to different soil mixes without losing effectiveness. Lastly, it is important that the cohesive additive not retard the growth of the seedlings.

This invention pertains to formulations for a cohesive soil plug, that can be transplanted from small tray cells into larger tray cells or pots, manually or by machine, without losing a significant amount of the growing medium from around the roots of the seedlings and thus preventing transplant shock. Growth rates are improved and production time is shortened.

The following potting soil and seedling soil mixes have been discovered by the inventors to provide soil plugs which have high cohesive soil properties at different moisture content levels. The mixes also appear to encourage rather than retard germination and plant growth.

Potting Mixes

| | | | |
|---|---|---|---|
| (1) | Potting soil mix | - | 150 g |
| | Bentonite | - | 10 g |
| (2) | Potting soil mix | - | 150 g |
| | Bentonite | - | 10 g |
| | Carboxyvinyl polymer | - | 0.5 g |
| (3) | Potting soil mix | - | 150 g |
| | Bentonite | - | 10 g |
| | Ethyl hydroxycellulose | | 1 g |
| (4) | Potting soil mix | - | 150 g |
| | Bentonite | - | 10 g |
| | vinyl acetate/vinyl | | |
| | versatate copolymer | - | 1 g |

The cohesive plug formulations according to the invention have several distinct advantages for growers over existing products. These are:

(1) The formulations can be adapted to existing grower processes.

(2) Existing grower equipment can be used.

(3) The cohesive additives used in the formulations can be added at various percentages to different soil mixes to achieve various objectives.

(4) The cohesive additives do not adversely affect plant growth.

| Typical Seedling Mix | Typical Propagation Mix |
|---|---|
| Fine peat moss | Regular grade peat moss |
| Fine perlite | Regular grade perlite |
| Fine vermiculite | |
| Micronutrients (S, B, Cu, Fe, | Micronutrients (S, B, Cu, Fe, |
| Mn, Mo & Zn) | Mn, Mo & Zn) |
| Gypsum (CaSO₄) | Gypsum (CaSO₄) |
| Dolomite (CaMg(CO₃)₂) | Dolomite (CaMg(CO₃)₂) |
| Limestone (CaCO₃) | Limestone (CaCO₃) |
| Monopotasium Phosphate | Calcium nitrate |
| | Potassium nitrate |
| | Iron sulphate |
| | Wetting agent |

Bentone EW and other suitable bentonite materials are available from L. V. Lomas Ltd., 718 Eaton Way, Annacis Island, Vancouver, British Columbia. Synthalen K™ (Carboxyvinyl polymer), Methocel™ (ethyl hydroxy cellulose) and other alkyl hydroxy cellulose thickeners are available from Norpac, 443 Terminal, Vancouver, British Columbia (suppliers of Dow Chemical alkyl hydroxy cellulose materials). Rhoximat PA050™, PAV22™ and PAV 27™ (vinyl acetate/vinyl versatate copolymers) are available from Canada Colors & Chemical Ltd. #106-15 11 Derwent Way, Annacis Isld, Vancouver, British Columbia.

A number of potential binding agents have been tested to date in an effort to discover a superior product. The following list is extensive, but not complete. Wyoming Bentonite, Bentone EW and Methocel have been dicovered as binding agents with successful results.

| Trade/generic name | Chemical Family | Result |
|---|---|---|
| Methocel | Ethyl hydroxy cellulose | Successful |
| Wyoming Bentonite | Bentonite 200 mesh | Successful |
| Bentone EW | Organophilic clay | Successful |
| Bermocoll | Ethyl hydroxyethyl cellulose | Successful |
| Natrosol | Methyl hydroxy cellulose | Moderately |
| | | successful |
| Casein | Casein | Failed |
| Acrysol | Acrylic polymer | Failed |
| Poly Vinyl Paroladone | Poly Vinyl Paroladone | Failed |
| Texipol | Acrylic polymer | Failed |
| Rhoximat PA 050 | polyvinyl acetate homopolymer | Failed |
| | and ethylene glycol monophenyl | |
| | ether | |
| Rhoximat PAV 22 | vinyl acetate/vinyl versatate | Failed |
| | copolymer, Kaolin and | |
| | Benzenedicarboxylic acid, dibutyl | |
| | ester | |
| Rhoximat PAV 27 | vinyl acetate/vinyl versatate | Failed |
| | copolymer, Kaolin and | |
| | Benzenedicarboxylic acid, dibutyl | |
| | ester | |
| Synthalen K | Carboxyvinyl polymer | Failed |

The following table illustrates average plug length of various plant binding agent formulas at different levels of stabilizer, at two different dates.

| | | December 6, 2001 | | | | | December 12, 2001 | | | | |
|---|---|---|---|---|---|---|---|---|---|---|---|
| | | | | | ave. plug | | | | | ave. plug | |
| Formula | code | rep 1 | rep 2 | rep 3 | length | SD | rep 1 | rep 2 | rep 3 | length | SD |
| 2% Casein, 2% EHEC | 1a | 70 | 50 | 0 | 40.0 | 36.1 | Discontinued treatment | | | | |
| 4% Casien, 4% EHEC | 1b | 85 | 30 | 50 | 55.0 | 27.8 | Discontinued treatment | | | | |
| 2% Bentonite, 2% EHEC | 2a | 95 | 85 | 80 | 86.7 | 7.6 | 95.0 | 95.0 | 80.0 | 90.0 | 8.7 |
| 4% Bentonite, 4% EHEC | 2b | 95 | 30 | 50 | 58.3 | 33.3 | 50.0 | 85.0 | 80.0 | 71.7 | 18.9 |
| 2% Casein, 2% Methocel | 3a | 80 | 60 | 80 | 73.3 | 11.5 | Discontinued treatment | | | | |
| 4% Casein, 4% Methocel | 3b | 60 | 30 | 70 | 53.3 | 20.8 | Discontinued treatment | | | | |
| 2% Bentonite, 2% Methocel | 4a | 100 | 95 | 95 | 96.7 | 2.9 | 80.0 | 100.0 | 100.0 | 93.3 | 11.5 |
| 4% Bentonite, 4% Methocel | 4b | 100 | 95 | 100 | 98.3 | 2.9 | 100.0 | 95.0 | 30.0 | 75.0 | 39.1 |
| 4% Casein | 5a | 95 | 80 | 80 | 85.0 | 8.7 | Discontinued treatment | | | | |
| 8% Casein | 5b | 80 | 70 | 70 | 73.3 | 5.8 | Discontinued treatment | | | | |
| Control | K | 75 | 60 | 60 | 65.0 | 8.7 | 75.0 | 70.0 | 70.0 | 71.7 | 2.9 |

As seen in the foregoing table, formulations 2a, 2b, 4a and 4b display high percentage plug lengths which indicates that smaller amounts of soil dropped away from the plug when the soil plugs were transferred from one tray cell to another tray cell (called flats).

The following table illustrates regular cropping schedules for certain plant species.

| | Time to | Time to | Other |
|---|---|---|---|
| Plant | rooting | shipping | (optimal pH for all plants = 5.5-6.2) |
| Nemesia spp. | 1-2 weeks | 3 weeks | |
| ‘Blue Bird’ | | | |
| Calibrachoa hybrid | 2 weeks | 4-5 weeks | Susceptible to root diseases |
| ‘trailing blue’ | | | |
| Petunia spp. | 3-4 weeks | 5 weeks | Hardest petunia to root |
| blue surfiinia | | | |
| Scaevola aemula | 4-5 weeks | 5-6 weeks | Easy, but slow (roots go to bottom - |
| ‘blue shamrock’ | | | hard to keep plug together) |
| Bracteantha | 4-5 weeks | 5-6 weeks | Heavy feeders (roots go to bottom - |
| bracteatu | | | hard to keep plug together) |
| Helichrysum | | | |

The following two tables show results at 15 days and 29 days for a number of cuttings of the foregoing plant species. At day 15, the 3% Bentone EW treatment resulted in longer plug lengths than the control across all plant species. On the same sampling date, the Bentone/Methocel treatment was better in two of four plant species. On day 29, plug strength was similar for both treatments and the control in three of four species. The plug strenght for Scaevola on day 29 was greater in the treated plugs than in the control plugs. It is suspected that by this date the root development of Nemesia, Petunia and Calibrachoa is significant enough to hold the soil to the root ball and thus obscure the effect of the treatment. However, better plug cohesion is evident earlier in treatment than that provided by roots alone. This demonstrates the potential for growers to shorten the cropping time.

Sampling - 15 days later

| | | | | | 3% Bentone EW + | | | | | |
|---|---|---|---|---|---|---|---|---|---|---|
| Plant | | 3% Bentone EW | | | 0.7% Methocel | | | Control | | |
| Nemesia | Roots | Roots to bottom of plug, most | | | Roots to bottom of plug, most | | | Roots to bottom of plug, plugs | | |
| | | plugs hold together around stem | | | plugs hold together around stem | | | don't hold together around stem | | |
| | | | | | | | | as well. | | |
| | Shoots | average | | | average | | | average | | |
| | Plug | 100 | 70 | 100 | 70 | 100 | 100 | 100 | 70 | 70 |
| Calibrachoa | Roots | Roots to bottom of plug | | | Roots to bottom of plug | | | Roots to bottom of plug | | |
| | Shoots | average | | | average | | | average | | |
| | Plug | Roots mostly on bottom half of | | | Roots mostly on bottom half of | | | Same root development, but soil | | |
| | | plug, but soil stays together | | | plug, but soil stays together | | | doesn't hold as well | | |
| | | around stem | | | around stem | | | | | |
| Petunia | Roots | Roots half way down plug | | | Roots half way down plug | | | Roots to bottom of plug | | |
| | Shoots | average | | | average | | | average | | |
| | Plug | Can pull plug by plant | | | Can pull plug by plant | | | Plugs not as cohesive | | |
| | | 100 | 60 | 100 | 100 | 100 | 100 | 50 | 50 | 50 |
| Scaevola | Roots | Roots to bottom of plug | | | Roots to bottom of plug | | | Roots to bottom of plug | | |
| | Shoots | average | | | average | | | average | | |
| | Plug | Soil stays around stem | | | Soil not as cohesive | | | Same as P4 | | |
| | | 100 | 100 | 100 | 100 | 50 | 0 | 100 | 50 | 0 |
| Helichrysum | Roots | none | | | ⅔ starting to root (a bit slower | | | ⅔ starting to root | | |
| | | | | | than control) | | | | | |
| | Shoots | average | | | average | | | average | | |
| | Plug | 50 | 0 | 50 | 50 | 0 | 0 | 50 | 0 | 0 |

Sampling - 29 days later

| | | | | | 3% Bentone EW + | | | | | |
|---|---|---|---|---|---|---|---|---|---|---|
| Plant | | 3% Bentone EW | | | 0.7% Methocel | | | Control | | |
| Nemesia | Roots | Roots look slightly thicker here | | | all root development looks the | | | all root development looks the | | |
| | | -otherwise all root development | | | same | | | same | | |
| | | looks the same | | | | | | | | |
| | Shoots | no difference between treatments | | | no difference between treatments | | | no difference between treatments | | |
| | Plug | 100 | 100 | 100 | 100 | 100 | 100 | 100 | 100 | 100 |
| Calibrachoa | Roots | Roots look slightly thicker and | | | roots throughout plug | | | roots throughout plug (maybe | | |
| | | plug has more roots at bottom | | | | | | more root hairs) | | |
| | Shoots | no difference between treatments | | | no difference between treatments | | | no difference between treatments | | |
| | Plug | 98 | 100 | 100 | 100 | 100 | 100 | 100 | 100 | 100 |
| Petunia | Roots | roots seem heavier and have | | | roots seem a bit less developed | | | roots seem a bit less developed | | |
| | | more root hairs | | | | | | | | |
| | Shoots | no difference between treatments | | | no difference between treatments | | | no difference between treatments | | |
| | Plug | 100 | 100 | 100 | 100 | 100 | 100 | 100 | 100 | 100 |
| Scaevola | Roots | Best - more roots throughout | | | roots at bottom and half way up | | | roots mostly at bottom | | |
| | | plug | | | plug | | | | | |
| | Shoots | no difference between treatments | | | no difference between treatments | | | no difference between treatments | | |
| | Plug | 100 | 100 | 100 | 100 | 100 | 100 | 50 | 40 | 60 |

| | |
|---|---|
| Helichrysum | Crop shipped out |

The following table shows that incorporated binding agents did not significantly affect the physical properties of soil plugs (pore space, water holding capacity and bulk density).

Physical Properties for Preliminary Plug Trials

| Porosity | | Total porosity (%) | | Aeration porosity (%) | | Water holding capacity (%) | | Bulk density (g/cm3) | |
|---|---|---|---|---|---|---|---|---|---|
| sample | Desc'n | average | SD | average | SD | average | SD | average | SD |
| A | 1% Casein | 65.3 | 5.8 | 6.4 | 0.8 | 58.9 | 4.9 | 0.10 | 0.00 |
| B | 1% Methocel | 66.7 | 0.9 | 5.2 | 1.2 | 61.5 | 1.8 | 0.10 | 0.00 |
| C | 1% EHEC | 66.7 | 1.7 | 4.3 | 1.8 | 62.4 | 2.5 | 0.10 | 0.01 |
| D | 1% Bentonite | 64.9 | 2.2 | 6.2 | 1.8 | 58.7 | 2.7 | 0.10 | 0.01 |
| E | 1% Natrasol | 64.7 | 2.7 | 4.3 | 2.4 | 60.4 | 4.9 | 0.10 | 0.01 |
| 1 | 1% Casein, 1% EHEC | 63.1 | 2.5 | 1.6 | 0.7 | 61.6 | 3.1 | 0.11 | 0.01 |
| 2 | 1% Bentonite, 1% EHEC | 65.4 | 2.9 | 3.8 | 2.6 | 61.7 | 2.2 | 0.11 | 0.01 |
| 3 | 1% Casein, 1% Methocil | 64.5 | 3.2 | 2.9 | 2.8 | 61.6 | 0.6 | 0.11 | 0.00 |
| 4 | 1% Bentonite, 1% | 64.7 | 3.9 | 1.5 | 1.1 | 63.2 | 3.2 | 0.12 | 0.00 |
| | Methocil | | | | | | | | |
| K | Control | 63.6 | 2.3 | 2.6 | 2.0 | 61.0 | 1.8 | 0.11 | 0.00 |

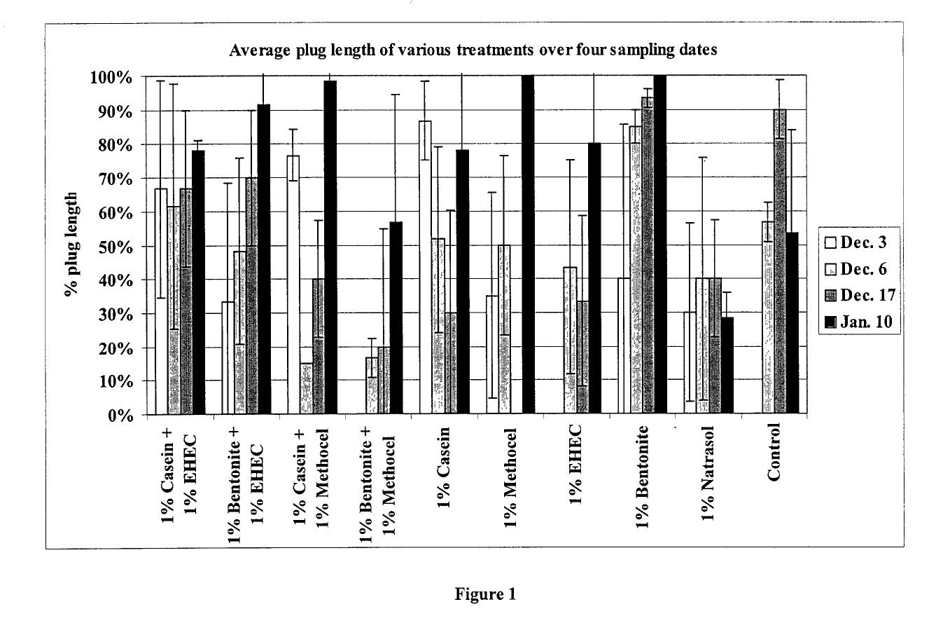

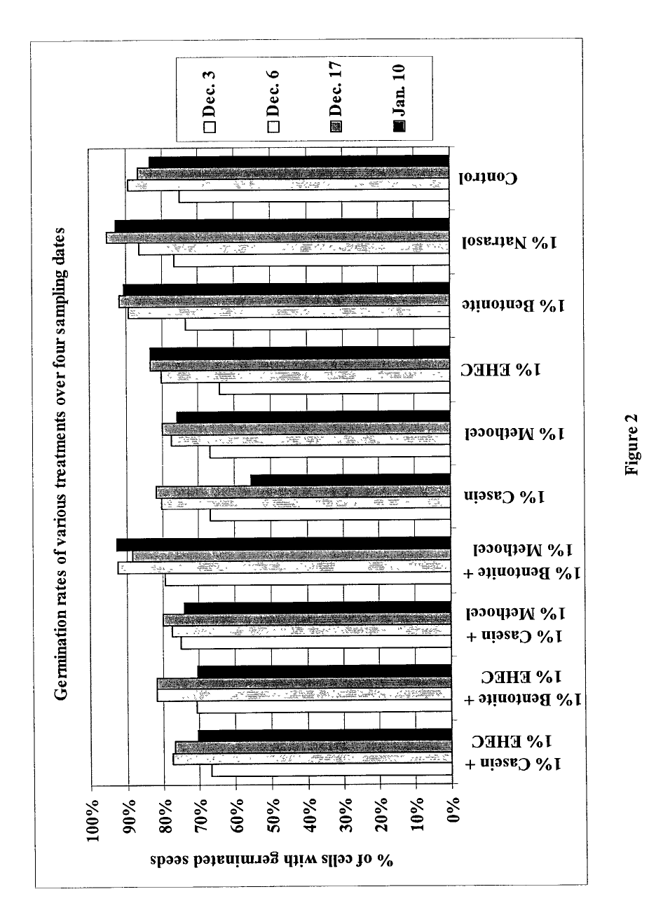

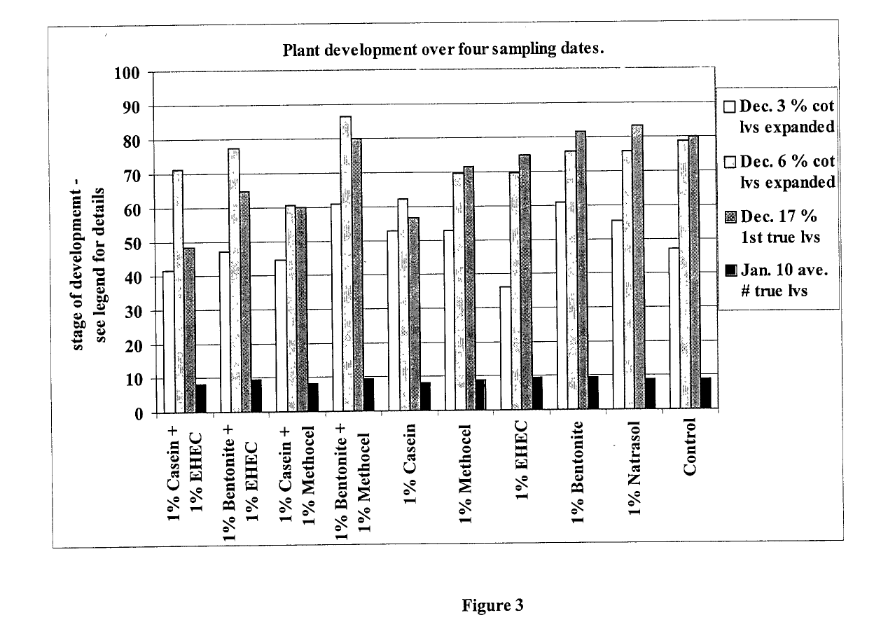

FIG. 1 illustrates a graph of average plug length for various treatments over four sampling dates. FIG. 2 illustrates a graph of germination rates of various treatments over four sampling dates. FIG. 3 illustrates a graph of growth rates of various treatments over four sampling dates. As can be seen, soil mixtures with bentonite, Natrasol™ (a methyl cellulose) and bentonite and Methocel™ (ethyl hydroxy cellulose) did well, particularly as the trials proceeded.

The following table illustrates resilience of plugs with various combinations of binding agents in potting and seeding soil.

In-lab Trials - start date Mar. 22/02

| | | # drops to |
|---|---|---|
| Formula | plug length | break plug |
| 6.7% Bentonite (in seeding soil) | 100 | 2.5 |
| 6.7% Bentonite + 0.3% Synthalen K (in | 75 | 3.5 |
| seedling soil) | | |
| 6.7% Bentonite + 0.7% Methocel (in | 65 | 6 |
| seedling soil) | | |
| 6.7% Bentonite + 0.7% Phoximat PA 050 | 95 | 1 |
| (in seedling) | | |
| Seedling soil only | 95 | 1 |
| 6.7% Bentonite (in potting soil) | 75 | 3 |
| 6.7% Bentonite + 0.3% Synthalen K (in | 100 | 2 |
| potting soil) | | |
| 6.7% Bentonite + 0.7% Methocel (in potting | 95 | 3.5 |
| soil) | | |
| Potting soil only | 90 | 1 |

As can be seen, combinations of 6.7% bentonite and 10% bentonite had superior percentage plug lengths to the sample having seedling soil only. Soil samples having compositions of bentonite and Synthalen K (carboxyvinyl polymer), and bentonite and Methocel™ (ethyl hydroxy cellulose), had superior resilience over the control sample (cont-P).

In addition to discovering preferred binding agents with superior properties, the inventors have also invented two types of successful cohesive plugs using two different processes, namely loose-fill plug and pre-fill peat based plug. For purposes of this invention and comprehension thereof, loose-fill plug and pre-fill peat based plug are described as follows.

Loose-Fill Plug

The Loose-fill Plug is prepared by using Methocel with Wyoming Bentonite and/or Bentone EW as the binding agent. For this plug the binding agents are blended dry into the soil mixture. The mix is then transported in bulk to the grower who then fills trays in the usual manner.

Pre-Fill Peat Based Plug

The Pre-fill peat based Plug employs one or more of the same binding agents as the Loose-fill Plug. However, the binding agents are first mixed at high speed in water to produce a slurry. Then, the binding agent slurry is blended into the soil mixture to wet out the soil. After mixing/aeration occurs, the trays are filled and set out to allow excess water to drain. The pre-filled trays are then shipped to the grower ready for immediate seeding/sticking.

The Loose-fill Plug formulations with the preferred binding agents at full grow out stage have shown some positive results. However, the Pre-fill Peat Based Plug at full grow out stage has demonstrated even better results across a wider variety of tray sizes and plants.

Three Loose-Fill Trials

Trials on the Loose-fill formulations according to the invention have been conducted at WestCan with seedlings (two trials with different soil mixes) and at Nordic with cuttings.

WestCan Seedling Trials

| Treatments | Soils | Varieties |
|---|---|---|
| Wyoming Bentonite | Seedling | Geraniums |
| Wyoming Bentonite + | #72 mix | Gerbera |
| Methocel | | Rudbeckia |
| Control | | |

Geraniums in Seedling Soil and 288 Trays

To reduce subjective evaluation and to identify significant positive results, statistical analysis was used. The statistical analysis conducted was a two-way analysis of variance between treatment and sampling date means. A completely randomized design with 5 replications was used. The results are summarized below.

| Source of Variation | df | F | P-value | F crit |
|---|---|---|---|---|
| Sampling Date | 3 | 7.6700 | 0.00027528* | 2.7981 |
| Binding Agent | 2 | 6.1522 | 0.00418220* | 3.1907 |
| Interaction | 6 | 1.4790 | 0.2054914 | 2.2946 |
| Exp. Error | 48 | | | |
| Total | 59 | | | |

There was no interaction between sampling date and plug strength. This means that treatments behaved consistently over sampling dates and therefore, treatment means (across dates) can be analyzed. The inventors found there was a significant effect of binding agent and sampling date on plug strength.

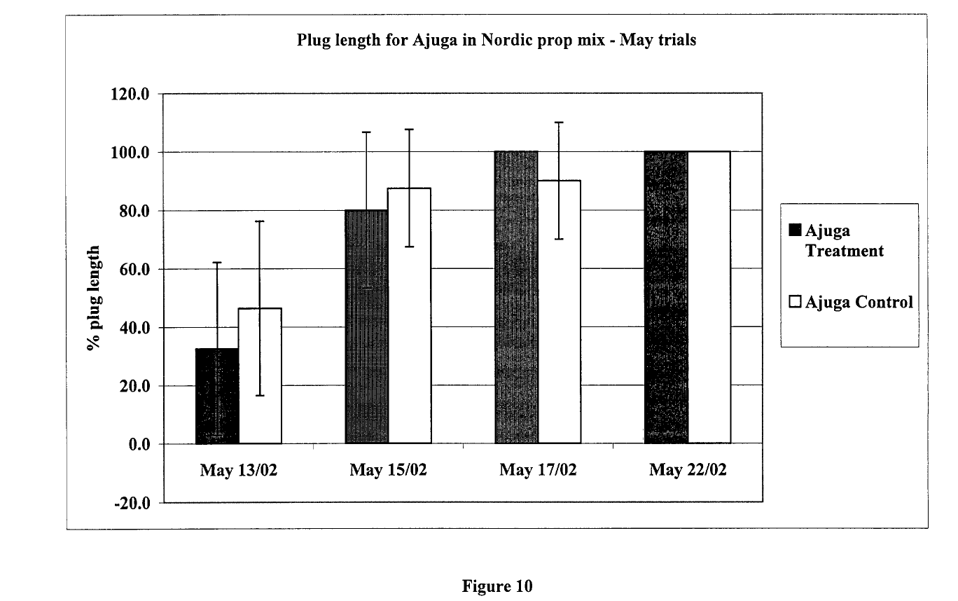

FIG. 10 shows that plugs with the Bentonite/Methocel treatment had a significantly greater average plug length than either the control or the Bentonite only treatment. Different letters (a, b and c) above the bars indicate that the treatment means are significantly different.

Rudbeckia in Seedling Soil and 288 Trays

The same analysis and evaluation design was used for Rudbeckia.

| Source of Variation | df | F | P-value | F crit |
|---|---|---|---|---|
| Sampling Date | 3 | 7.3264 | 0.00038567* | 2.7981 |
| Binding Agent | 2 | 14.6740 | 0.0000106* | 3.1907 |
| Interaction | 6 | 2.0072 | 0.0830060 | 2.2946 |
| Exp. Error | 48 | | | |
| Total | 59 | | | |

Again, it was found there was no interaction between sampling date and plug strength. There was a significant effect of binding agent and sampling date on plug strength.

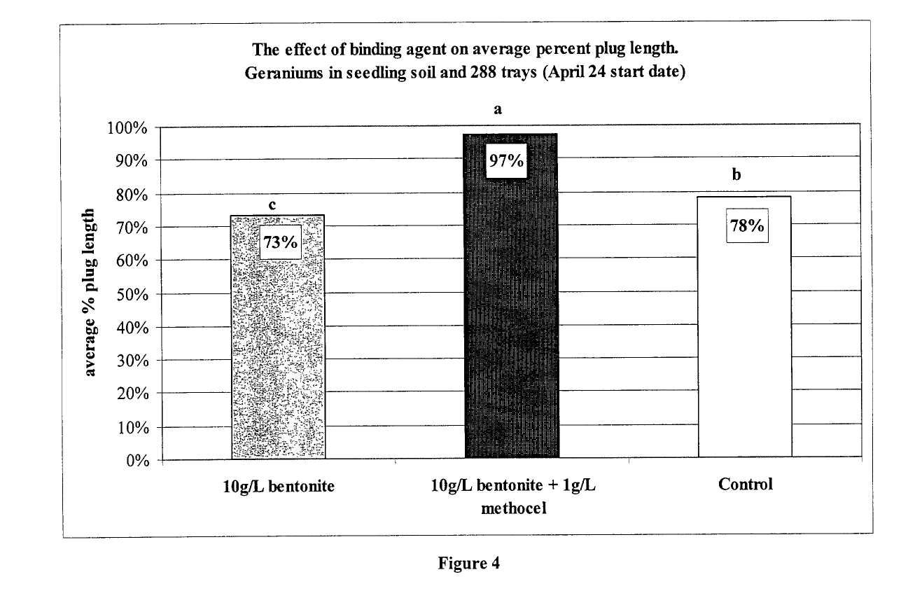

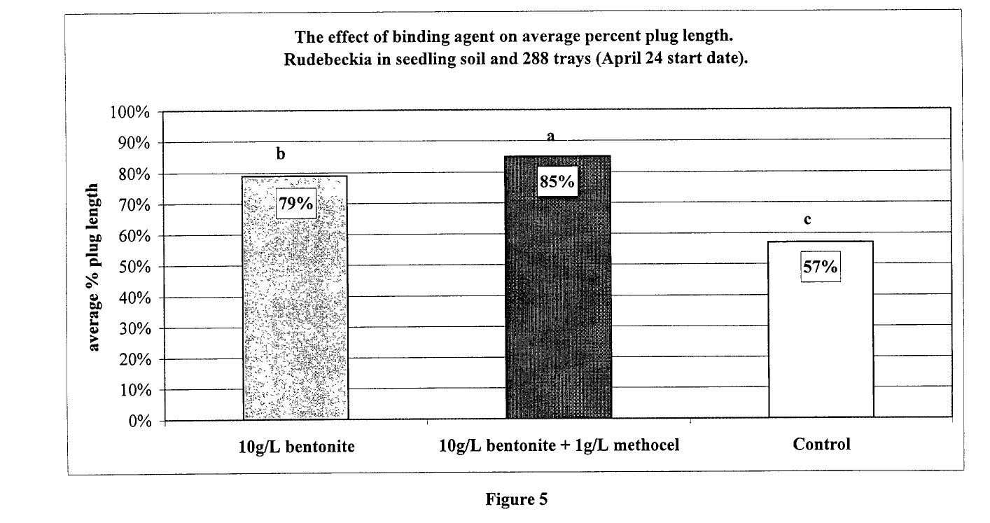

FIG. 5 illustrates a graph of the effect of binding agent on average percent plug length for Rudebeckia in seedling soil. The Bentonite/Methocel binding agent was found to be superior. The Bentonite only treatment was better than the control in the Rudbeckia, but worse than the control for the Geraniums (FIG. 4). This is probably due to the fact that plug strength is a function of both binding agent and root development. The Geraniums had germinated by day 6 and put out a new set of leaves every week after that.

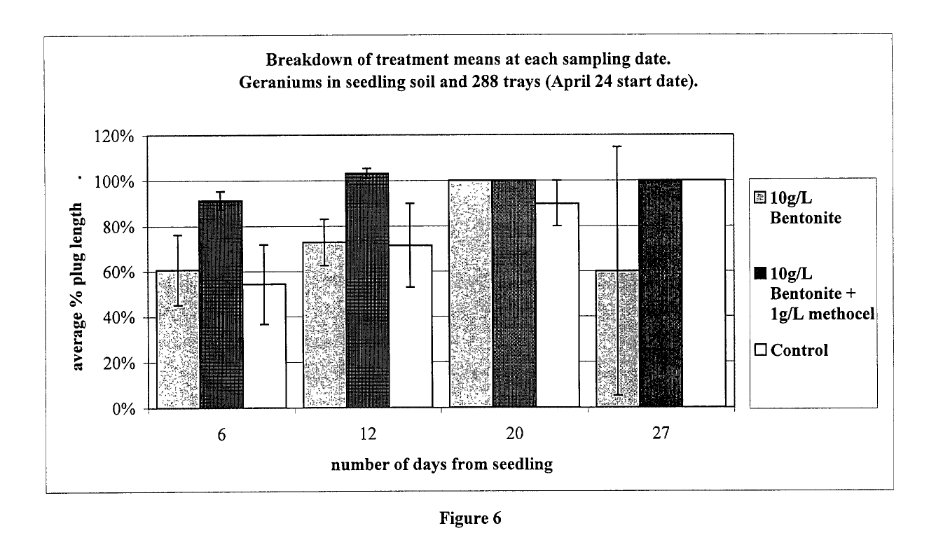

FIG. 6 illustrates a graph of breakdown of treatment means for Geraniums in seedling soil. The graph in FIG. 6 shows that by day 20, the plug length for the control is nearing that of the Bentonite/Methocel treatment. This is an indication that root development plays a strong role in plug cohesion beyond day 20 in this crop.

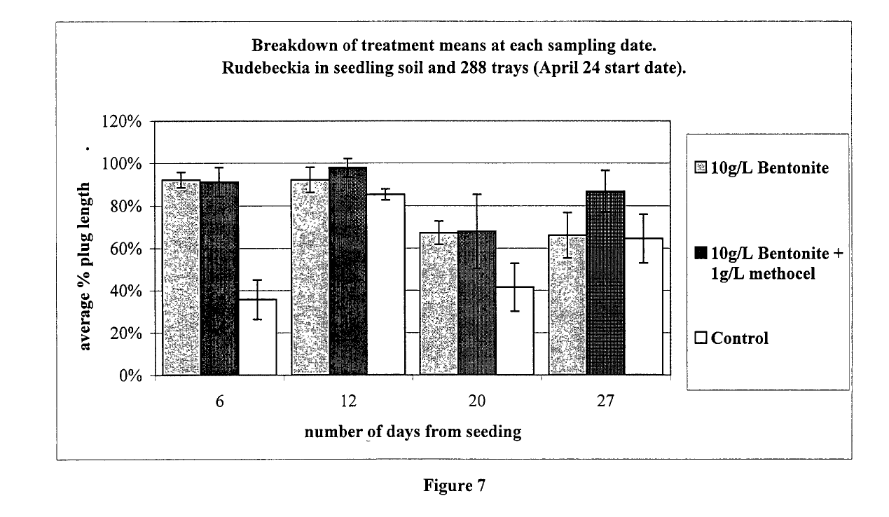

Relative to the Geraniums, Rudbeckia germination was very poor and development was very slow (only 1-2 true leaf stage at day 27). Root development at this stage in this crop is not an important factor in plug integrity. This experiment demonstrates plug strength in the absence of the effect of root development. FIG. 7 illustrates a graph of breakdown of treatment means for Rudebeckia in seedling soil. The graph in FIG. 7 shows that plug strength did not increase steadily over sampling dates as was the general trend for Geraniums. Upon further investigation, it was noted that the soil moisture content was high on days 6 and 20. The average plug length of treatments with binding agent was less affected by high moisture content than the control.

Gerbera in #72 Soil and 252 Trays

The same analysis and design as described previously was used for Gerbera.

| Source of Variation | df | F | P-value | F crit |
|---|---|---|---|---|
| Sampling Date | 3 | 10.7618 | 0.0000159* | 2.7981 |
| Binding Agent | 2 | 0.5125 | 0.6022211 | 3.1907 |
| Interaction | 6 | 0.2075 | 0.9727572 | 2.2946 |
| Exp. Error | 48 | | | |
| Total | 59 | | | |

The above results indicated no interaction between sampling date and plug strength, no significant effect of binding agent on plug strength and a significant effect of sampling date on plug strength.

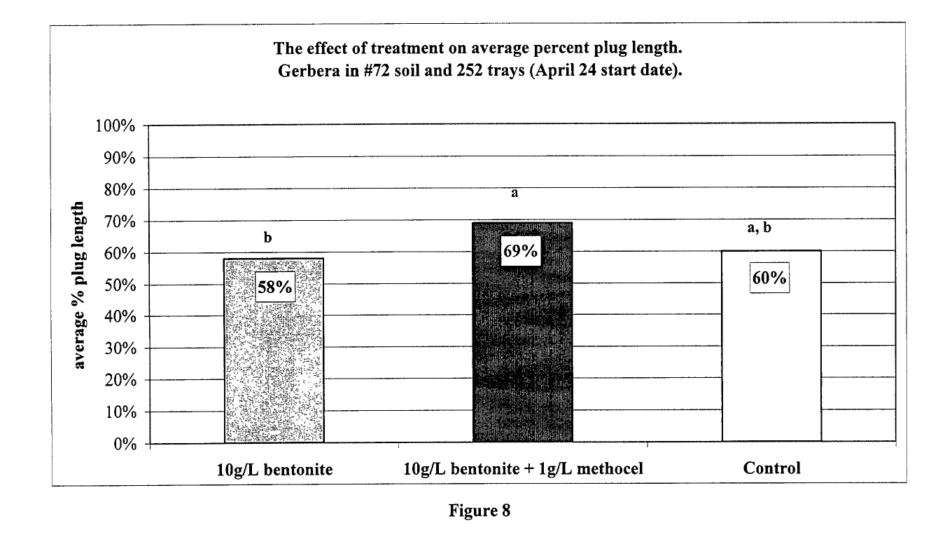

FIG. 8 illustrates a graph of the effect of treatment on average percent plug length for Gerbera in #72 soil. The graph in FIG. 8 shows that the treatment means were not significantly different from the control, but the trend was similar to that seen previously (that is, the Bentonite/Methocel binder was the best).

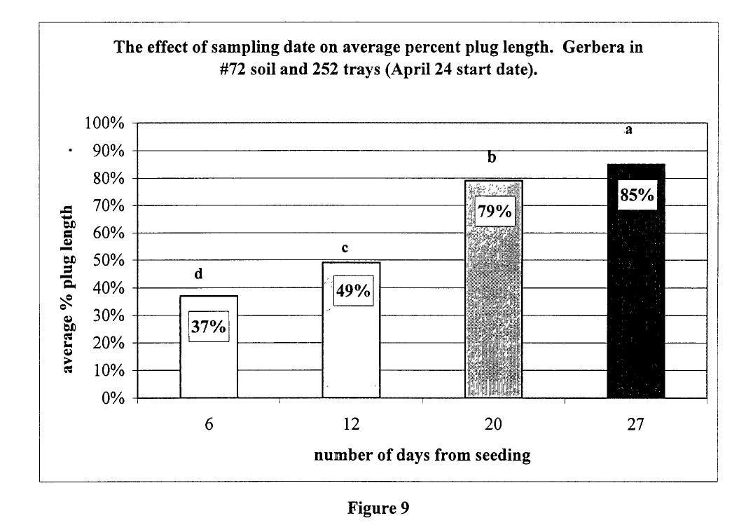

Gerbera is a fast growing variety. However, the plant is susceptible to root rot and thus is grown under relatively dry conditions in a coarse soil mix. FIG. 9 illustrates a graph of the effect of sampling date on average percent plug length for Gerbera in #72 soil. FIG. 9 shows a fast and steady increase in plug strength, which is most closely correlated to root development. The ineffectiveness of the binding agent is most likely a reflection of the coarse mix and dry growing conditions, and not the type of binding per se.

According to the results of our tests, plug strength is a factor of binding agent, root development, soil moisture (too much/too little) and, particle size of soil mix. This means that for specific crops/conditions soil mixes and trays there is a significant effect of binding agent on plug strength.

Nordic Trials with Cuttings

| Treatments | Soils | Varieties |
|---|---|---|
| Wyoming Bentonite + | Nordic prop mix in a 105 | Herman's Pride |
| Methocel | tray | Ajuga |
| Control | | Gentians |
| | | Ceratostigma |

The trials at Nordic were set up in completely randomized design with 10 replications. The treatment variances were not homogenous and so data was not analyzed statistically. FIGS. 10, 11, 12 and 13 show the variability in treatment response over progressive sampling dates for four different varieties.

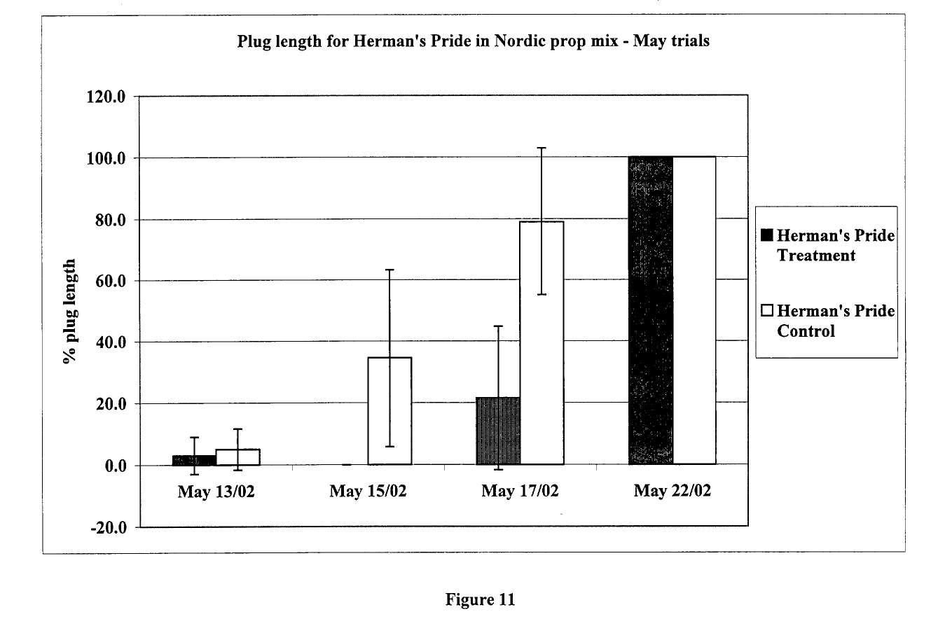

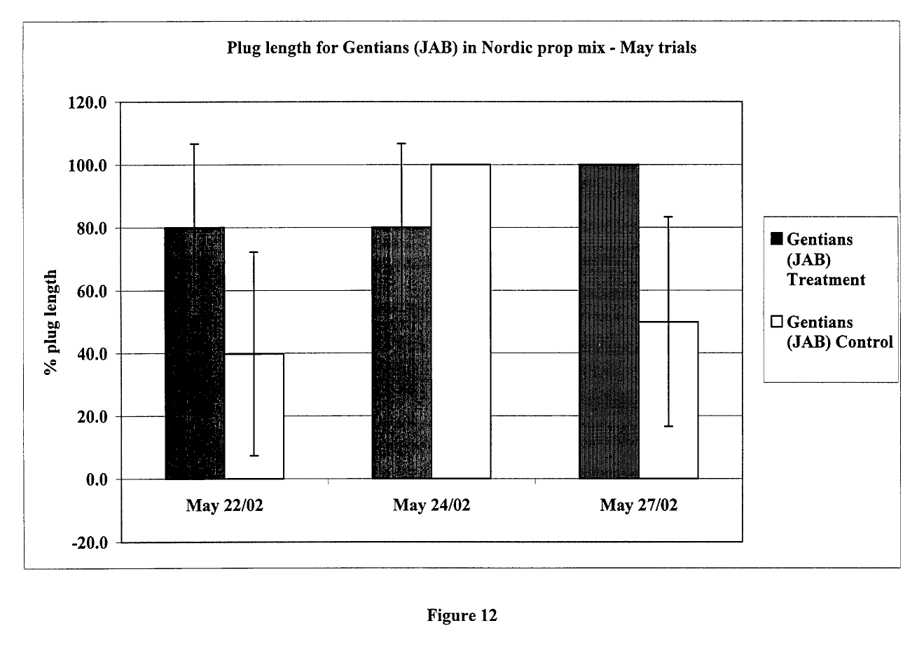

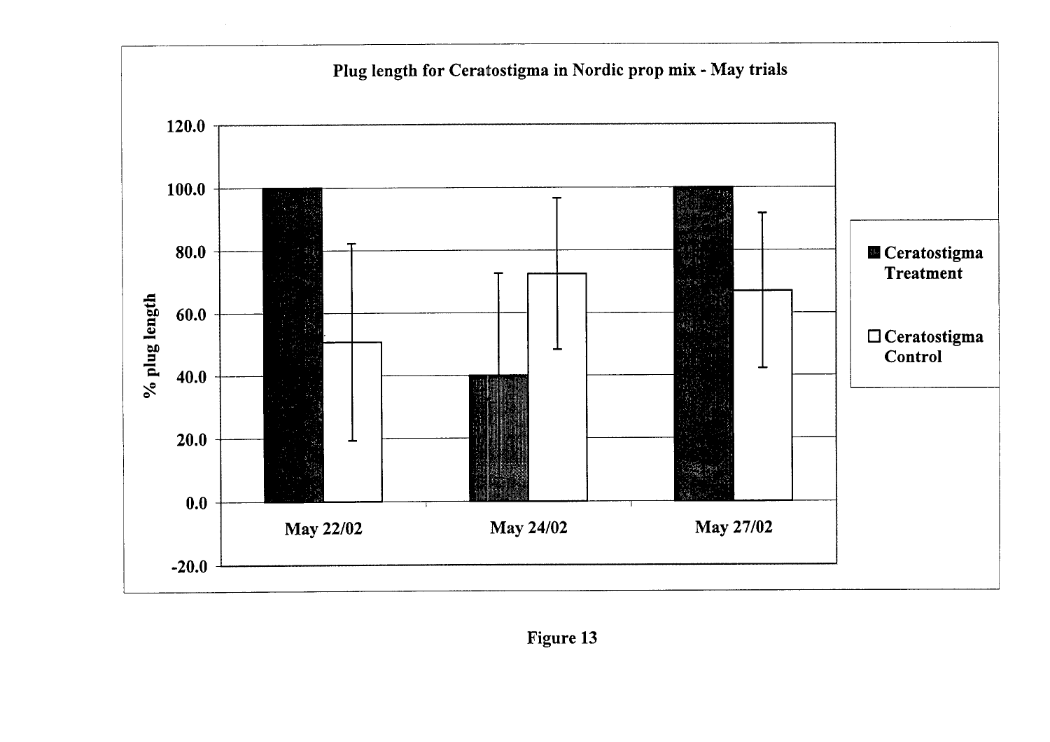

FIG. 10 illustrates a graph of % plug length for Ajuga over four dates. FIG. 11 illustrates a graph of % plug length for Herman's Pride over four dates. FIG. 12 illustrates a graph of % plug length for Gentians over four dates. FIG. 13 illustrates a graph of % plug length for Ceratostigma over three dates.

Due to the large variability in the data obtained, the inventors concluded that for consistency and credibility the skilled transplanter should transplant entire trays in the conventional manner. The following table summarizes the results of this exercise. Two trays (reps) were transplanted for each variety. The pulled plugs were categorized by visual observation into 100-75% intact, 74-51% intact and >50% intact. The averages for each category are compared below.

| | | total | | | |
|---|---|---|---|---|---|
| June 3, 2002 | rep | pulled | 100-75% | 74-51% | >50% |
| Gentians Treatment | 1 | 105 | 103 | 0 | 2 |
| | 2 | 105 | 105 | 0 | 0 |
| | average | | 99.0% | | 1.0% |
| Gentians Control | 1 | 104 | 103 | 0 | 1 |
| | 2 | 105 | 105 | 0 | 0 |
| | average | | 99.5% | | 0.5% |
| Ceratostigma Treatment | 1 | 105 | 102 | 1 | 2 |
| | 2 | 94 | 84 | 2 | 10 |
| | average | | 93.5% | 1.5% | 6.0% |
| Ceratostigma Control | 1 | 105 | 96 | 6 | 3 |
| | 2 | — | — | — | — |
| | average | | 91.4% | 5.7% | 2.9% |
| Helichrysum Treatment | 1 | 104 | 104 | 0.0 | 0.0 |
| | 2 | — | — | — | — |
| | average | | 100.0% | | |
| Helichrysum Control | 1 | — | — | — | — |
| | 2 | — | — | — | — |
| | average | | | | |

The plant varieties involved here are known to be slow rooting. Of these slower rooting varities, Gentians are the fastest/easiest and Helichrysum are the slowest/most difficult to root. For Gentians, there was no difference between treatment and control. For Ceratostigma, the treatment provided better plug pull, however the grower terminated the experiment while pulling the second control tray as the plugs were suffering a certain amount of damage and there was concern about crop and hence money loss. In this variety, the grower nonetheless thought the soil treatment according to the invention would be a benefit. For Helichrysum, the first treatment tray was pulled, but the results for all trays afterwards were poor and the grower discontinued the experiment. The grower nonetheless thought that this variety would warrant the use of this plug, but was not willing to suffer monetary loss at the time of the evaluation.

The foregoing data pertains to dry mixes or loose fill. The inventors have also invented and discovered that wet pre-fill mixes show very promising results.

The following is a summary of grower trials for pre-fill Bentonite/Methocel plugs. The trials included five treatments that were chosen specifically to answer the following three questions. 1) Does the process of pre filling the trays alone contribute to plug strength? 2) Are perlite and vermiculite necessary for aeration in the plug and do they affect plug strength? 3) Does the binding agent (10 g/L Bentonite+1 g/L Methocel) contribute to plug strength?

The five treatments include:

Control Mix Loose-fill: The usual soil mix was used for sticking these cuttings. These trays were filled as usual by the grower.

Control Mix Pre-fill: A regular mix was used as above, but the trays were pre-filled at West Creek Farms using the same procedure that the treated pre-fill trays received.

Control Peat Pre-fill: The soil used for this trial was the regular mix minus the perlite and vermiculite. Trays were pre-filled at West Creek Farms.

Bentonite/Methocel Mix Pre-fill: A regular mix plus a binding agent was used and the trays were pre-filled at West Creek Farms.

Bentonite/Methocel Peat Pre-fill: A regular mix minus perlite/vermiculite plus the binding agent was used. Trays were pre-filled at West Creek Farms.

Many treatments and a couple of variables are possible within each treatment. To simplify treatment names, the first term (control or Bentonite/Methocel) is intended to indicate whether or not binding agent was added. The middle term (mix or peat) indicates whether or not perlite/vermiculite was added. The last term indicates whether trays were pre-filled or loose-filled.

A two way statistical analysis of variance (table below) indicated that:

1) The treatments behave consistently between the two sampling dates; and

2) There is a significant effect of treatment and date on % plug intact.

Analysis of Variance
(A.N.O.V.A.)

| Source of Variation | SS | df | F | P-value | F crit |
|---|---|---|---|---|---|
| Sample (date) | 1.2002 | 1 | 5.0439 | 0.0291 | 4.0343 |
| Columns (treatments) | 7.3734 | 4 | 7.7468 | 0.0001 | 2.5572 |
| Interaction | 0.5921 | 4 | 0.6221 | 0.6488 | 2.5572 |
| Within | 11.8975 | 50 | | | |
| Total | 21.0632 | 59 | | | |

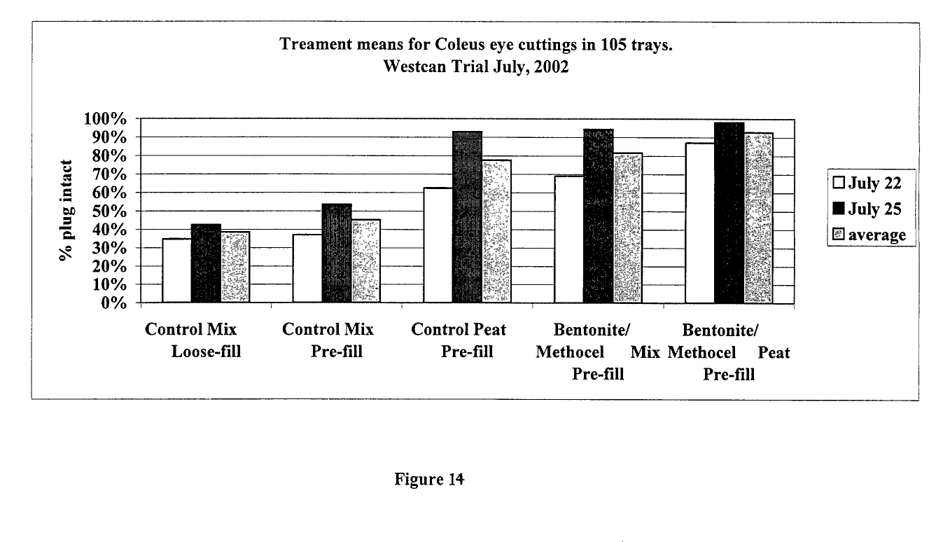

The next step in the analysis is to determine which treatment means are different. FIG. 14 illustrates a graph of treatment means for Coleus eye cuttings. The graph shows treatment means by date and treatment averages over both sampling dates. Since the A.N.O.V.A indicated that the treatments behaved consistently over the two sampling dates, the average of the two dates for each treatment was used when comparing the treatment means.

Comparing the Treatment Means:

Control Mix Loose-fill vs. Control Mix Pre-fill: the only factor that is different between these treatments is the process of filling trays (ie. pre-fill vs. loose-fill). Since the means are not statistically different, it follows that the process of pre-filling trays alone does not significantly improve plug strength.

Control Peat Pre-fill vs. Control Mix Pre-fill and Bentonite/Methocel Peat Pre-fill vs. Bentonite/Methocel Mix Pre-fill: The only variability factor in both of these comparisons was substrate (ie. mix vs. peat only). The means for the peat only treatments are significantly greater than the means for the mix treatments. It follows that better plug strength is obtained when peat only is used. There was no visible difference in development of roots or root hairs between the Mix and Peat treatments.

Control Peat Pre-fill vs. Bentonite/Methocel Peat Pre-fill and Control Mix Pre-fill vs. Bentonite/Methocel Mix Pre-fill: The only factor varied in both of these comparisons was the presence/absence of Bentonite and Methocel. Both treatments with the binding agent were significantly larger than without. It follows that plug strength is significantly improved by the presence of a binding agent.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An adhesive soil mixture comprising:
(a) plant growing medium; and
(b) a binder selected from one or more of the group consisting of bentonite and cellulose alkyl ether.

2. A mixture as claimed in claim 1 wherein the binder is bentonite.

3. A mixture as claimed in claim 1 wherein the binder is cellulose alkyl ether.

4. A mixture as claimed in claim 1 wherein the binder is cellulose methyl ether.

5. A mixture as claimed in claim 1 wherein the binder is bentonite and cellulose alkyl ether.

6. A mixture as claimed in claim 1 wherein the binder is bentonite and cellulose methyl ether.

7. A mixture as claimed in claim 1 comprising about 150 parts plant growing medium and about 1 to 20 parts bentonite.

8. A mixture as claimed in claim 7 wherein the proportion of bentonite is about 10 parts to about 150 parts growing medium.

9. A mixture as claimed in claim 1 comprising about 150 parts growing medium, about 1 to 20 parts bentonite and about 0.1 to 4 parts cellulose methyl ether.

10. A mixture as claimed in claim 1 wherein the plant growing medium and the binder are mixed in a dry state before filling plant growing trays.

11. A mixture as claimed in claim 7 wherein the plant growing medium and the binder are mixed with about an equal amount of water before filling plant growing trays.

12. A mixture as claimed in claim 11 wherein the plant growing medium is peat moss and fertilizer.

13. A composition suitable for forming soil plugs comprising:
(a) about 150 parts growing medium;
(b) about 10 parts bentonite; and
(c) about 1 part cellulose methyl ether.

14. A composition as claimed in claim 13 wherein cellulose hydroxy ethyl ether is substituted for cellulose methyl ether.

15. An adhesive soil mixture comprising: (a) growing medium containing one or more of peat moss, perlite, vermiculite, sulfur, boron, copper, iron, manganese, molybdenum, zinc, gypsum, dolomite, limestone, hydrated limestone, monopotassium phosphate, single super phosphate, calcium nitrate, potassium nitrate, iron sulphate, and/or wetting agent; and (b) a binder containing one or more of bentonite and cellulose alkyl ether.
